(19) United States
(12) Patent Application Publication
(10) Pub. No.: US 2025/0182155 A1
(43) Pub. Date: Jun. 5, 2025

(54) INFORMATION PROMPT METHOD AND ELECTRONIC DEVICE

(71) Applicant: Hangzhou Alibaba International Internet Industry Co., Ltd., Hangzhou (CN)

(72) Inventors: Ruiyao Jiang, Hangzhou (CN); YuJen Huang, Hangzhou (CN); Chao Guo, Hangzhou (CN); Xiaohua Chen, Hangzhou (CN); Xuguang Qi, Hangzhou (CN); Ang Gao, Hangzhou (CN); Siqi Cheng, Hangzhou (CN)

(21) Appl. No.: 18/962,918

(22) Filed: Nov. 27, 2024

(30) Foreign Application Priority Data
Nov. 30, 2023 (CN) 202311636848.9

(51) Int. Cl. G06Q 30/0207

(52) U.S. Cl. CPC G06Q 30/0222

(57) ABSTRACT

Disclosed in embodiments of the present application are an information prompt method and an electronic device. The method comprises: acquiring, in a process of responding to a user's request to access a target page, matching status information of the commodities in a selected set of commodities associated with the user that matches at least one target user offer and completion information on a task corresponding to a redeem condition of the target user offer; generating, based on the matching status information and the completion information, prompt information about the target user offer, and providing a first content layer and a second content layer in a display interface, wherein the first content layer being configured to display content of the target page, and the second content layer comprises elements for displaying the prompt information. Through the embodiments of the present application, the user operation path may be optimized, which is conducive to improving indicators such as commodity click-through rate, “add to cart rate,” conversion rate, and verification and utilization rate of user offers.

### CROSS-REFERENCE TO RELATED APPLICATIONS

This Application claims priority to CN application No. 202311636848.9, filed Nov. 30, 2023, titled “INFORMATION PROMPT METHOD AND ELECTRONIC DEVICE”, which is fully incorporated herein by reference.

### TECHNICAL FIELD

The present application relates to the technical field of information processing, and more particularly, to an information prompt method and an electronic device.

### BACKGROUND

In a commodity information service system, users are often provided with a variety of user offers, such as coupon offers, or “discounts for purchases over a certain amount” offers, or “free shipping for purchases over a certain amount” offers, and so on. In a conventional scenario, after a user adds commodities to a “shopping cart” through various commodity pages using various shopping guide links, and when the user accesses the “shopping cart” page to select some commodities therein and is ready for checkout, a prompt of whether or not the redeem conditions for using a certain user offer have been met is usually provided on the “shopping cart” page. For example, if one commodity is included in the campaign of “$30 off $200,” and if a user picks this commodity on the “Shopping Cart” page and is ready to check out, a prompt about the commodity being eligible for the “$30 off $200” offer may be displayed on the “Shopping Cart” page. If the redeem conditions have been met (for example, the total dollar amount of the commodities eligible for the same campaign and the dollar amount is more than $200), the dollar amount that has already been subtracted may be prompted and displayed. If the conditions are not met, the dollar difference between the total dollar amount of the currently selected commodities and the threshold in the redeem condition may also be prompted, for example, “Spent $xx and get $30 off.” If the specific redeem conditions include multiple different tiers, the currently offered discount under the met tier and the difference relative to the next tier and other information can also be prompted, and so on. If the user finds that the conditions for using the offers have not been met, or wants to meet the redeem conditions for using the next tier to get more discounts, the user will need to return to the commodity page to select other commodities and add these to the shopping cart; then the user needs to access the “Shopping Cart” page to see whether the redeem conditions for using the offers have been met, and the like.

### SUMMARY

Provided in the present application are an information prompt method and an electronic device to optimize the user operation path, which are conducive to improving indicators such as commodity click-through rate, “add to cart rate,” conversion rate, and verification and utilization rate of user offers.

The present application provides the following solutions:

An information prompt method, comprising:
acquiring, in a process of responding to a user's request to access a target page, matching status information of the commodities in a selected set of commodities associated with the user that matches at least one target user offer and completion information on a task corresponding to a redeem condition of the target user offer; and
generating, based on the matching status information and the completion information, prompt information about the target user offer, and providing a first content layer and a second content layer in a display interface, wherein the first content layer being configured to display content of the target page, and the second content layer comprises an element for displaying the prompt information.

Herein, the target page is a page corresponding to multiple nodes on any shopping guide links in a commodity information service system.

The method is applied to target function modules in the form of a software development kit (SDK), so that the target function modules may be implanted, by means of the SDK, into pages corresponding to a plurality of nodes on shopping guide links of a plurality of access link nodes.

The selected commodity set includes commodities selected from pages corresponding to the plurality of nodes on the plurality of shopping guide links.

The acquiring, in the process of responding to the user's request to access the target page, the matching status information of the commodities in the selected set of commodities associated with the user that matches at least one target user offer and the completion information on the task corresponding to the redeem condition of the target user offer comprises:
acquiring, after receiving the user's request to access the target page and before the target page is displayed, the matching status information of the commodities already added to the selected set of commodities that matches at least one target user offer within the most recent threshold time and the completion information of the task corresponding to the redeem condition of the target user offer, so that when a matched target user offer is found, the element is displayed at the time when the target page is displayed.

The method further comprises:
before the target page is displayed, if the commodities in the selected set of commodities do not match any of the target user offers, displaying the element in the target page when the commodities in the target page are newly added to the selected set of commodities and match at least one target user offer.

Herein, when the commodities in the selected set of commodities match a plurality of target user offers, prompt information respectively corresponding to the plurality of target user offers is provided in the element.

If a task completion dollar difference of the redeem condition for the target user offer is less than a preset threshold, recommended commodity information is pushed by means of the element, the recommended commodities being within the eligible range for the target user offer and an associated price attribute being slightly greater than the task completion dollar difference of the redeem condition.

The method further comprises:
after commodities in the target page are newly added to the selected set of commodities, if a change in the matching status information and/or the completion information is triggered, updating a style of the element and/or the content of the prompt information presented therein.

Herein, the updating the style of the element and/or the content of the prompt information presented therein comprises:
after the commodities in the target page are newly added to the selected set of commodities and if the newly added commodities match new target user offers, adding, to the element, the prompt information about the new target user offers.

When the respective prompt information corresponding to the plurality of target user offers is displayed by means of the element, the prompt information respectively corresponding to the plurality of the target user offers is differentiated and shown using different colors.

Herein, the target page comprises a page configured for displaying information of the plurality of commodities in an aggregated manner; and
the method further comprises:
providing, on the target page, an operation option for filtering commodities according to different target user offers, wherein a color attribute of the operation option is consistent with a color attribute of the prompt information corresponding to the target user offer.

Herein, the updating the style of the element and/or the content of the prompt information presented therein comprises:
after the commodities in the target page are newly added to the selected set of commodities, and if such results in the task completion dollar difference of the redeem condition of the corresponding target user offer being less than the preset threshold, pushing the recommended commodity information by means of the element, wherein the recommended commodities being within an eligible range for the target user offer, and the associated price attributes being slightly greater than the task completion dollar difference of the redeem condition.

Herein, the updating the style of the element and/or the content of the prompt information presented therein comprises:
after the commodities in the target page are newly added to the selected set of commodities, and if such changes a task status of the redeem condition of the corresponding target user offer to complete, displaying, by means of the element, a commodity subset within the selected set of commodities related to the target user offer and a corresponding checkout operation option, so as to initiate a checkout operation for the commodities in the commodity subset by means of the element.

The method further comprises:
redirecting, after the element is executed by a target operation, to a page corresponding to the selected set of commodities for display, and classifying and displaying the commodities thereon according to the different matched target user offers.

The method further comprises:
displaying, after the element is executed by a target operation, the commodity information related to the majority of target user offers in the selected set of commodities by means of the element, and providing an operation option for initiating the checkout operation.

An information prompt method, comprising:
in a process of displaying, in a display interface, page content of a target page by means of a first content layer, if it is detected that a user adds a target commodity seen in the target page to a selected set of commodities, it is determined whether the target commodity matches a target user offer; and if so, displaying completion information on a task corresponding to a redeem condition of the target user offer; and
generating, based on the matching information and the completion information, prompt information about the target user offer, and providing, in a second content layer of the display interface, an element for displaying the prompt information.

The method further comprises:
if a task corresponding to a redeem condition of the target user offer is not completed, including, in the prompt information, progress information of the task and the task completion dollar difference information.

The method further comprises:
if the task completion dollar difference information is less than a preset threshold, recommended commodity information is further pushed by means of the element, the recommended commodity being within the eligible range for the target user offer, and an associated price attribute being slightly greater than the task completion dollar difference of the redeem condition.

The method further comprises:
if the task corresponding to the redeem condition of the target user offer is completed, displaying, by means of the element, a commodity subset within the selected set of commodities related to the target user offer and a corresponding checkout operation option, so as to initiate a checkout operation for the commodities in the commodity subset by means of the element.

An information prompt method, comprising:
acquiring, in a process of responding to a user's request to access a target page, available user offer information associated with the user;
generating prompt information about the redeem conditions of the available user offer information, and providing a first content layer and a second content layer in a display interface, wherein the first content layer is configured to display content of the target page, and the second content layer comprises an element for displaying the prompt information; and
after commodities in the target page are added to a selected set of commodities and if the redeem conditions are met, providing prompt information about the available user offers for purchasing the commodities by means of the element.

The method further comprises:
when the element provides prompt information about the available user offers for purchasing commodities, providing, in the element, an operation option for initiating checkout for the commodities, so as to initiate the checkout for the commodities in the target page.

A display interface, wherein the display interface comprises:
a first content layer and a second content layer, the first content layer is configured to display content of a target page, the target page being used to display commodity information; and the second content layer comprises an element for displaying prompt information related to user offers, wherein the prompt information is generated based on a matching status of commodities in a selected set of commodities associated with a user that matches user offers and completion status information on tasks corresponding to redeem conditions of the target user offers.

A computer-readable storage medium having stored thereon a computer program which, when executed by a processor, implements the steps described in any of the above-described methods.

An electronic device, comprising:
one or more processors; and
a memory associated with the one or more processors, the memory being configured to store program instructions which, when read and executed by the one or more processors, execute the steps described in any of the above-described methods.

According to specific embodiments provided by the present application, the present application discloses the following technical effects.

Embodiments of the present application enable the following: in the process of displaying the target page, an element for guiding and prompting the user based on the user offers-related information may be provided. Specifically, the element may be used to display which commodities in the “shopping cart” associated with the user match what user offers and the completion status of the corresponding tasks, and the like. Through this solution, in the process of selecting commodities in the commodity information page, the user would be more aware of completing tasks such as “add-on orders” that is related to the use of the user offers. As such, the user offer information may be more effective in guiding the user to “add to cart,” thereby improving indicators such as commodity click-through rate, “add to cart rate,” conversion rate, etc., and it is also conducive to improve the verification and utilization rate of user offers.

Herein, in an optional implementation, when the user performs relevant operations in the current target page which leads to the change in the matching status of the user offers and/or in the task completion status, the style of the element and/or the presented content of the prompt information may further be updated so that the user may be able to perceive the changes more intuitively.

In the specific process of providing smart guiding prompts, the element used for providing guiding prompts may have features such as being scalable, providing content with more varieties, etc. For example, in terms of the content variety, after a user has a new action such as “add to cart” on the current page, and if the task corresponding to the redeem conditions of a certain user offer is close to complete, the element may proactively push to the user commodities that may be used for “add-on orders,” so that the user may complete the “add-on order” directly using the element. Alternatively, if the user makes a new “add to cart” action on the current page and the redeem condition for using a certain user offer is met, the commodity information related to the user offer in the “shopping cart” may be extracted and displayed by means of the element. In addition, an operation option for initiating the checkout may be provided, so that the user can directly initiate the checkout using the above-mentioned element on the current page without having to return to the “shopping cart” page to initiate the checkout, thereby shortening the user's operation path.

In addition, from the perspective of technical implementation, the above-mentioned smart guiding and prompting function regarding user offers may be provided in the form of SDK. In this way, this SDK may be implanted in different pages corresponding to a plurality of different nodes in the shopping guide links, so that the above-mentioned guiding and prompting function may be uniformly presented in different pages. For example, different user offers may be presented in different colors in the element. When a page provides options for filtering commodities based on user offers, the options corresponding to different user offers may also be provided in different colors, which are consistent with the colors used for the corresponding user offers in the element. For the above scenario, when implemented through a unified SDK, the display logic of the elements themselves can be unified, and further, the correspondence between the user offers and the colors may be unified on different pages, so that users gradually form the mindset that they can identify user offers by the colors.

Implementation of any solutions of the present application does not necessarily need to achieve all of the advantages described above.

### BRIEF DESCRIPTION OF DRAWINGS

To describe the technical solutions in the embodiments of the present application or in the prior art more clearly, the following briefly describes the accompanying drawings required for describing the embodiments. Apparently, the accompanying drawings in the following description are merely some embodiments of the present application, and those of ordinary skill in the art may further derive other accompanying drawings from these accompanying drawings without inventive efforts.

FIG. 1 is a schematic diagram of a system architecture provided in an embodiment of the present application;

FIG. 2 is a flowchart of a first method provided in an embodiment of the present application;

FIG. 3 is a schematic diagram of an interface provided by an embodiment of the present application;

FIG. 4 is a schematic diagram of various modes of a “smart guiding prompt” element provided in an embodiment of the present application;

FIG. 5 is a schematic diagram of the commodity prompts provided through the “smart guiding prompt” element in an embodiment of the present application;

FIG. 6 is a schematic diagram of displaying commodity information in a “shopping cart” through the “smart guiding prompt” element provided in an embodiment of the present application;

FIG. 7 is a schematic diagram of a “shopping cart” page provided in an embodiment of the present application;

FIG. 8 is a flowchart of a second method provided in an embodiment of the present application;

FIG. 9 is a flowchart of a third method provided in an embodiment of the present application;

FIG. 10 is another schematic diagram of an interface provided in an embodiment of the present application; and

FIG. 11 is a schematic diagram of an electronic device provided in an embodiment of the present application.

### DESCRIPTION OF EMBODIMENTS

The technical solutions in the embodiments of the present application will be clearly and completely described below with reference to the accompanying drawings in the embodiments of the present application. Apparently, the described embodiments are merely some, but not all, of the embodiments of the present application. Based on the embodiments in the present application, all other embodiments obtained by those of ordinary skill in the art shall fall within the protection scope of the present application.

First of all, it should be noted that in a commodity information service system, the user offers that may be used may be different in different time periods (for example, daily period, promotion period, etc.) and may also be different for users with different membership levels and different groups. In addition, there are some user offers that may be used across stores, such as “cross-store discounts.” Therefore, when users are browsing through a specific commodity information service system, they usually do not have a clear concept of which user offers may be used, or they may only know whether a certain offer may be used for a selected commodity, but are “unaware” of whether the conditions for using the offers have been met (especially when users can place “add-on orders” for commodities from other stores), how much discount they will be able to get, etc. Only after the users are directed to the “shopping cart” page to check out the commodities will they obtain therefrom information about whether the conditions for using the user offers have been met, how much discount they can get, and how much dollar difference there is before the user offers may be used. At this point, if the redeem conditions have not been met, or if the users want to meet the conditions for the next tier and thus get more discounts, they need to return to the commodity page to select commodities. Some systems may certainly offer, in the “Shopping Cart” page, options such as “Proceed to place add-on orders” for the users, and users may then use this option to access the corresponding landing page and select suitable commodities to place the “add-on order.” However, this only provides convenience in placing “add-on orders,” but has no effect on the users' perception of whether the conditions for using user offers have been met in the normal course of users browsing commodity pages.

In response to the above situation, in an embodiment of the present application, a “smart guiding prompt” function may be provided to users, and this function may be provided in the page (for example, the client homepage, category channel page, event venue page, store page, commodity details page, and certainly include the “shopping cart” page, “add-on order page,” etc.) corresponding to any node on the shopping guiding link (referred to as “shopping guiding link”) in the system. In this way, when users “add to cart” the commodities through a page that provides the above functions, they can receive guiding tips related to specific user offers. For example, during the course of a user browsing a page, if the above functions are implemented therein, a dedicated element may be provided while the page content is displayed. Relevant prompt information may be displayed using the element. This prompt information may remind the user of which commodities the user has added to the “shopping cart” match what user offers and the completion progress thereof. Further, more abundant information may be provided thereon. For example, the prompt information may indicate the dollar difference if the conditions have not been met, what discounts may be obtained after the conditions are met, etc. If there are multiple matching user offers, prompt information corresponding to the multiple user offers may be provided in the element. For example, the completion progress of various user offers may be displayed. Considering the size of the element, only the completion details of a certain user offer may be displayed, and so on. In this way, users may use this such information to make a more conscious selection of commodities to “add to cart” on the current page. If the user chooses a commodity to add to the “shopping cart” on the current page, which leads to a change in the matching status of the user offers and/or completion progresses, the prompt information may also be directly updated by means of the element. During the update process, the format of the element may also be changed. For example, the size of the element may be scaled according to the amount of to-be-provided prompt information or the prompt intensity.

In addition, regarding the content of the prompt information, in addition to providing information about completion progress, dollar difference, available discounts, etc., more abundant information may also be provided through the above-mentioned elements. For example, if it is found that the task dollar difference to meet a certain user offer is lower than a preset threshold, the element may be used to proactively push to the user commodities that may be used for “add-on orders,” so that the user may complete the “add-on order” on the current page directly using the element. Alternatively, if the user chooses to add a commodity to the “shopping cart” on the current page and the redeem conditions for a certain user offer are met, the element may be enlarged, and some related animations may be played to provide with the user a strong reminder, so that the user may better perceive that the task corresponding to the redeem condition for using the user offer has been completed. In addition, the commodity information corresponding to the user offer in the “shopping cart” may be extracted and displayed by means of the element, and the checkout option may be provided. As such, the user can initiate checkout directly by means of the element without having to return to the specific “shopping cart” page to initiate the checkout. Therefore, the user's operation path may be further shortened. In short, in various pages where shopping guide function is provided, the element may be used to provide users with a variety of rich guiding information. This element can certainly exist independently of a specific page, i.e., not implemented on a specific page. Instead, the element may be a global element that is displayed in the process of displaying various different pages. Further, this element may, in the process of displaying different pages, have a unified information prompt logic.

In summary, through the embodiments of the present application, the aforementioned element with the smart guiding and prompting function may be used to provide users with various and rich information that is related to user offers, and the element may be displayed in the process of displaying a variety of different pages. From the perspective of technical implementation, the support of the above functions can be accomplished by each page individually. However, in order to maintain the uniformity of such elements when they are displayed in a plurality of different pages and to reduce the development costs of page developers, a unified SDK (software development kit, i.e., a toolkit provided by a service provider to implement a certain function of the product software) can also be provided. As such, the above-mentioned functional modules may be implanted into specific pages through this SDK, and the specific page developer does not need to be concerned about the specific implementation of the functions, thereby reducing the development cost thereof. At the same time, the display of specific smart guiding information may be unified among the plurality of different pages.

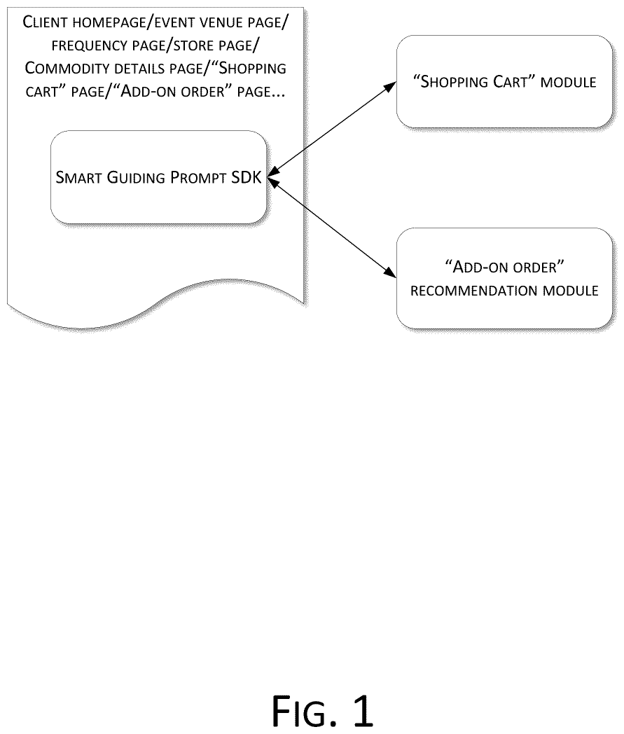

From the perspective of system architecture, referring to FIG. 1, in a specific implementation, the above-mentioned SDK is provided in the embodiment of the present application, and the specific SDK may be implanted into different pages corresponding to multiple nodes on specific shopping guide links, so that these pages are equipped with smart guiding prompt functions related to user offers. Herein, during the smart guiding prompt process, the SDK may interact with the “shopping cart” module, “add-on order” recommendation module, and other modules, so as to provide users with richer information by means of the elements that correspond to the above-mentioned smart guiding prompt functions.

The specific implementation solutions provided by the embodiments of the present application are described in detail below.

### Embodiment I

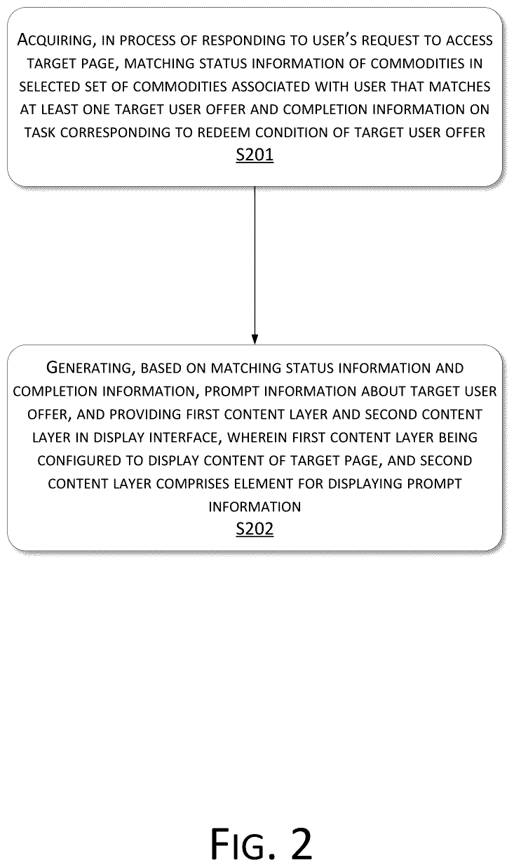

First, Embodiment I of the present application provides an information prompt method. Referring to FIG. 2, the method may include:

S201: Acquiring, in a process of responding to a user's request to access a target page, matching status information of the commodities in a selected set of commodities associated with the user that matches at least one target user offer and completion information on a task corresponding to a redeem condition of the target user offer.

Among them, the target page may be the page corresponding to the plurality of nodes on any shopping guide link within the commodity information service system. For example, the target page may be the client homepage, commodity recommendation page, channel page, event venue page, store page, and commodity details page, and it may also be the “shopping cart” page, “add-on order” page, and so on.

The selected set of commodities may specifically refer to a set of commodities that the use adds to the “shopping cart”. Specifically, the selected set of commodities may include commodities selected from pages corresponding to the plurality of nodes on the plurality of shopping guide links. In other words, the specific “shopping cart” may be shared by multiple stores, and the items that users choose to add to the “shopping cart” from a number of different stores, different event venues, etc. may be aggregated into the same “shopping cart,” which is also the basis for making user offers such as “cross-store discounts.”

In the embodiment of the present application, if the aforementioned smart guiding prompt function is implemented therein, guiding prompt information related to user offers may be provided when the user visits such a page. Specifically, in order to provide the above guiding prompt information, firstly, matching status information of the commodities in a selected set of commodities associated with the user that matches at least one target user offer and completion information on a task corresponding to a redeem condition of the target user offer may be acquired. The matching status information refers to the determination of whether the commodities in the selected set of commodities match one or several user offers; the completion status information means that specific user offers are usually associated with corresponding redeem conditions, which may be tasks for users. Only when the corresponding tasks are completed so that the redeem conditions are met can the benefits brought by the specific user offers be obtained. For example, if the redeem condition corresponding to a certain user offer is “Spent over $10,” then a user might need to complete the “add-on order” task, which means that the redeem condition of “Spent over $10” will be met when the “add-on order” task is completed. For example, if a user offer is “$30 off $200,” it means that the commodities to be purchased by a user need to worth at least $200 to get the discount “$30 off.” If a single item is less than $200, it may be combined with other commodities to form an “add-on order.” Of course, the other commodities also need to be within the eligible range for the user offer. In this case, for a specific user offer, if there is a commodity in the “shopping cart” that matches the user offer, but the redeem condition thereof may not be met yet, meaning the user has completed only part of the task that corresponds to the redeem condition of the user offer. As such, the concept of “task completion status” is brought into play. The specific task completion status may further include the progress of task completion and the details of task completion, among which “progress” may be specifically expressed by percentage and “details” may include the specific task dollar difference, i.e., the dollar difference between the total price of the commodities in the “shopping cart” that match the user offer and the dollar amount set in the redeem conditions of the user offer. In addition, discounts and deals that the users might obtain after meeting the redeem conditions may further be included.

In a specific implementation, there may be multiple opportunities to obtain the above information. For example, in one implementation, after the user's request to access the target page is received and before the target page is displayed, the matching status information of the commodities already added to the selected set of commodities that matches at least one target user offer within the most recent threshold time and the completion information of the task corresponding to the redeem condition of the target user offer may be acquired. That is to say, although the user has just landed on the target page, because the commodities that the user has recently added to the shopping cart (for example, commodities added to the “shopping cart” within the last N days or within the last N hours, which may be selected by default) match one or several user offers, the user may be guided and prompted directly on the current target page. That is, the user can directly view the element for guiding and prompting for user offer information on the page.

Of course, if the commodities in the selected set of commodities do not match any target user offers, it is also possible to temporarily not provide the above-mentioned element in the target page. When subsequently the commodities in the target page are newly added to the selected set of commodities and match at least one target user offer, the element will be displayed therein. Alternatively, when there is no matching user offer information, some other relevant information may also be pushed to the user by means of this element, for example, introducing a certain user offer, and so on.

S202: Generating, based on the matching status information and the completion information, prompt information about the target user offer, and providing a first content layer and a second content layer in a display interface, wherein the first content layer being configured to display content of the target page, and the second content layer comprises an element for displaying the prompt information.

After the matching status of the items in the “shopping cart” that matches the user offers and the completion status thereof is acquired, prompt information about the specific use offer may be generated based on such information, and this prompt information may be displayed through an element. In an embodiment of the present application, this element may be independent of the current target page, i.e., a smart guiding function not being provided by the current target page. Therefore, specifically when the element is displayed, it may also be independent of the content of the target page. Specifically, two content layers may be provided in the display interface, wherein the first content layer may display the page content of a specific target page, such as a commodity information list, and the second content layer is configured to display the above element. As such, since the element and the content of the target page are in different content layers, and the second content layer can usually be located above the first content layer, the element appears to “hover” or “float” above the page content.

Therefore, this element may also be figuratively referred to as a “smart guiding prompt island.” For user offers such as “discounts for purchases over a dollar amount,” since the task that users need to complete is to make an “add-on order,” the “smart guiding prompt island” is mainly used to show information about “add-on order.” Therefore, it can also be further figuratively called an “add-on item island,” and so on.

The specific prompt information may include the completion progress and/or completion details of the task corresponding to the redeem conditions of the specific user offers. In other words, through the element used for showing smart guiding prompts, which commodities that the user has added to cart match what user offers and the corresponding task completion progress may be displayed; additionally, the specific task dollar difference (how much dollar amount is needed to meet the redeem conditions for the user offers, etc.), information about discounts that may be obtained after meeting the redeem conditions, etc. may further be included.

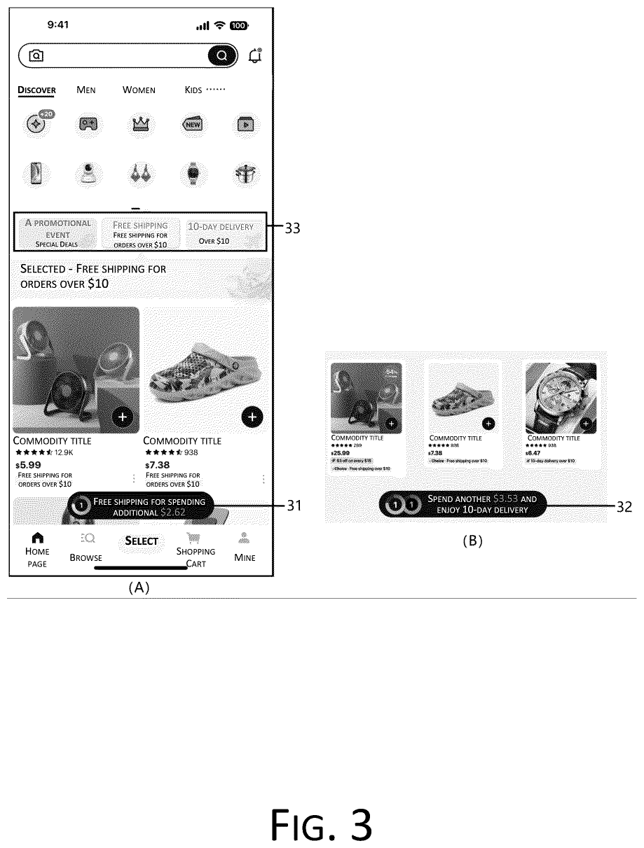

For example, as illustrated in FIG. 3 (A), a target page is shown, and information of a number of recommended commodities is provided thereon. In a traditional way, users can select specific commodities of interest and add those to the “shopping cart” while browsing the page. Although it is possible to know whether a specific commodity added to the shopping cart is eligible for a certain user offer through the commodity details page or the tags provided in the above-mentioned commodity recommendation page, whether the redeem conditions for using the corresponding user offer have been met can only be determined when checkout is to be conducted on the shopping cart page. In the embodiment of the present application, as shown at 31 in FIG. 3, which is the element provided by the embodiment of the present application, however, information such as the matching status of the commodities in the specific “shopping cart” that matches user offers and the task completion status may be directly obtained in the course of browsing the current commodity recommendation page. For example, in this example, a “circle” style task completion progress bar may be provided in the element, and specific task completion details can also be provided, such as “spent another $2.62 to get free shipping.” With this information, users can be clearly made aware that there is already a commodity with “free shipping for orders over $10” in their “shopping cart,” but the redeem conditions are not met yet. If they spend an additional “$2.62”, the “free shipping” condition will be met. That is to say, when users intend to purchase commodities through a specific commodity information page, they do not need to visit the “shopping cart” page to check for information, but may instead directly acquire information such as the completion status of user offers on the current commodity information page. With this method, the completion status information of user offers may play a role in guiding the users' operations such as adding items to cart, allowing users to make a more conscious selection of commodities, thus helping to improve indicators like commodity click-through rate, conversion rate, and others. At the same time, it is also beneficial in prompting the redemption utilization rate of user offers.

If a task completion dollar difference of the redeem condition for the target user offer is found to be less than a preset threshold, recommended commodity information is further pushed by means of the element, the specific recommended commodities being within the eligible range for the target user offer and an associated price attribute being slightly greater than the task completion dollar difference of the redeem condition. The push of such commodity information may certainly take place after the user performs a further “add to cart” operation on the current page, for which an examples will be provided later.

When the commodities in the selected set of commodities match a plurality of target user offers, prompt information respectively corresponding to the plurality of target user offers may be provided in the element. In other words, the task completion progress, task completion details and the like of the plurality of the matched user offers may be prompted in the same element. Of course, since the size of the element may be limited, regarding the task completion details, the task completion details of only one user offer may be displayed, and so on.

In order to facilitate differentiation, when the respective prompt information corresponding to the plurality of target user offers is displayed by means of the element, the prompt information respectively corresponding to the plurality of the target user offers is differentiated and shown using different colors. For example, as shown at 32 in FIG. 3 (B), assuming that there are three matched different user offers, three different colored “circle” style progress bars may be provided in the element to show their respective completion progress. At the same time, the task completion details of one of the user offers are also displayed in the element, where the task completion details may be expressed in text. In order to facilitate the determination of which user offer the currently shown details correspond to, the color of the task completion details text may also be made consistent with the color of the corresponding progress bar. For example, in the example shown in FIG. 3 (B), the task completion details show the completion details of the user offer of “$6 off $50,” which means that “spending an additional $9.01 to get $6 off.” At this time, the specific information related to the dollar amount may be displayed in the same color as the progress bar of the corresponding user offer.

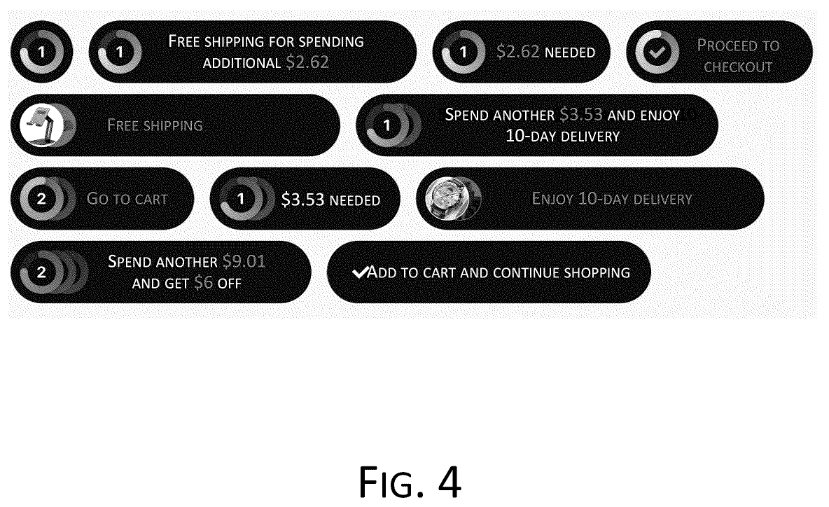

It should be noted that regarding the above-mentioned specific element, the style thereof may be changed dynamically in different pages, or when different prompt information needs to be displayed, including being able to be enlarged or reduced, etc. For example, FIG. 4 shows various formats of the element in various situations. Of course, there may be other formats in actual applications. The examples shown herein are for illustration and should not be deemed as limiting the scope of protection of the present application.

In addition, for a target page that aggregates and displays information of a number of commodities, for example, a client homepage as shown in FIG. 3 (A), or a commodity recommendation page, a commodity search result page, etc., an operation option for filtering commodities according to different target user offers may also be provided, and a color attribute of the operation option is consistent with a color attribute of the prompt information corresponding to the target user offer. For example, as shown at 33 in FIG. 3 (A), three operation options corresponding to different user offers are provided, namely, “special deal,” “free shipping for orders over $10,” and “10-day delivery for orders over $10.” A user may filter the commodities that support the corresponding user offers by clicking on the specific operation options. For example, in the example shown in FIG. 3 (A), if the user offer of “free shipping for orders over $10” is selected, the page may mainly display commodity information that supports the “free shipping for orders over $10.” In addition, since the page also provides the prompt information shown at 31 in FIG. 3 (A), which means that the user's “shopping cart” already has commodities that support the “free shipping for orders over $10,” and as long as the user adds another commodity worth “$2.62,” the “free shipping” condition may be met. At this time, if the user would like to obtain the benefits this offer provides, the user may select other commodities from the filtered commodities and add them to the “shopping cart” to complete the “add-on order,” It can be seen that in this way, the specific prompt information provided can play a guiding role in the user's purchase process, so that the user can be more conscious of completing the “add-on order” operation in the course of browsing the commodity information page and making purchases thereon.

In addition, in the case where the target page is provided with the above-mentioned specific guiding prompt information for “add-on order,” if the user performs the operation of adding a new commodity to the “shopping cart” in the current target page, and as such a change is observed in the matching status information of the user offer and/or the completion information, the style of the element and/or the content of the prompt information presented therein may also be updated. That is to say, when a user makes an “add to cart” action in the current page, the user may be made aware of the impact of the “add to cart” action on the matching of specific user offers and/or completion information through the changes in information in the aforementioned element in the current page.

The changes in matching of specific user offers and/or completion information may vary in various specific situations. Accordingly, the changes in information of the elements may also be different. For example, after the commodities in the target page are newly added to the selected set of commodities and if the newly added commodities match new target user offers, then the prompt information about the new target user offers is added to the element. For example, similar to what is shown in FIGS. 3 (A) and (B), assuming that one of the commodities in the user's “shopping cart” is originally eligible for a “free shipping” offer. At this time, the display of the element may be as shown in 31 in FIG. 3 (A). In the course of browsing the page, the user adds one of the commodities to the “shopping cart,” and the commodity is eligible for a “10-day delivery” offer. In this case, as shown in 32 in FIG. 3 (B), prompt information about the offer may be added to the element, including how much money to spend to meet the redeem conditions for the offer.

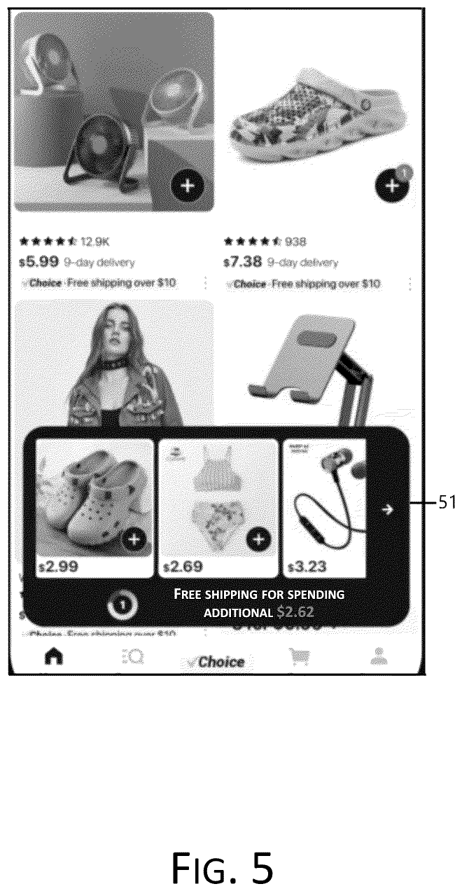

Alternatively, in another case, after the commodities in the target page are newly added to the selected set of commodities, the task completion dollar difference of the redeem condition of the corresponding target user offer might be less than the preset threshold. In other words, after a commodity is added to the “shopping cart,” the distance to the redeem conditions “threshold” of the corresponding user offer is shortened. At this time, the element can also be enlarged, and recommended commodity information may be pushed by means of the element. The recommended commodities can be within the eligible range for the target user offer, and the associated price attributes are slightly greater than the task completion dollar difference of the redeem condition (that is, the difference between the price of the recommended commodity and the task completion dollar difference is less than a preset threshold). For example, as shown at 51 in FIG. 5, assuming that the user adds a commodity to the “shopping cart” on the current page, so that the difference is only “$2.62” to meet the redeem condition for the “free shipping” offer. At this time, the aforementioned element may be enlarged, and the recommended commodity information may be displayed by means of the element. The recommended commodities are all commodities that support the “free shipping” offer, and the prices thereof are all slightly greater than “$2.62.” In this way, users can directly view the recommended commodity information from the element, and can also directly add the commodity to the “shopping cart,” thereby achieving guiding users to conveniently complete the “add-on order.”

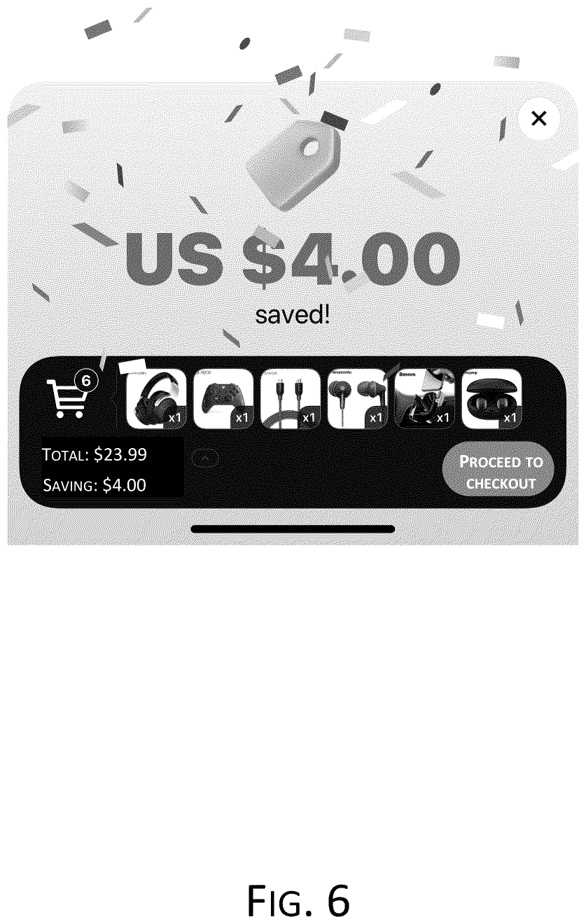

In addition, after the commodities in the target page are newly added to the selected set of commodities, and if such changes a task status of the redeem condition of the corresponding target user offer to complete, then the element may be enlarged for display. A commodity subset within the selected set of commodities related to the target user offer and a corresponding checkout operation option are displayed by means of the element, so as to initiate a checkout operation for the commodities in the commodity subset through the target page. That is to say, if the “add to cart” operation performed by the user in the current page makes the corresponding user offers meet the redeem condition, the commodities related to the user offers in the “shopping cart” may be extracted and displayed in the element used for smart guiding prompts in the current target page, and operation options such as “proceed to checkout” may be provided. For example, the specific display effect may be as shown in FIG. 6. This allows users to initiate checkout directly on the current target page without having to view commodities on the “shopping cart” page, etc. It should be noted that in the above-mentioned process of enlarging and displaying the element, it is also possible to provide users with a visual effect with higher prompt intensity by displaying corresponding motion effects or adding atmosphere elements therein.

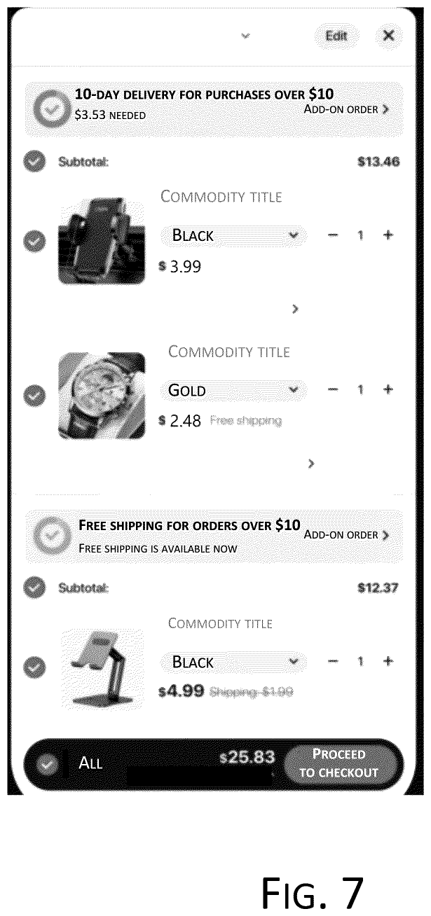

Furthermore, if the user clicks on the above-mentioned element for smart guiding prompts in the target page, the user may be redirected to the “shopping cart” page, which is displayed to the user, and the commodities may be classified and displayed in the “shopping cart” page according to the corresponding user offers. For example, as shown in FIG. 7, the commodities in the “shopping cart” may be categorized and displayed according to different user offers such as “10-day delivery for purchases over $10” and “free shipping for purchases over $10.” Herein, the color attributes of the labels corresponding to different user offers can still be consistent with the color attributes used to show the corresponding user offers in the elements mentioned above, so that the colors corresponding to the same user offers are shown in a unified manner in different pages. In addition, an “add-on order” option may be provided for various user offers. If the redeem conditions for using the user offers are not yet met, the “add-on order” option may be used to access the “add-on order page” so that the commodities may be continuously selected. The aforementioned element for guiding and prompting information related to user offers may continue to be provided on the “add-on order page.”

Alternatively, in another manner, after the element is clicked or other target operations are performed, instead of redirecting the user to the “shopping cart” page immediately, the element may be used to display the commodity information related to the majority of target user offers in the selected set of commodities, and an operation option for initiating the checkout operation may be provided. Thus, users may initiate checkout by means of the element without having to be redirected to the “shopping cart” page to do so. After the checkout is conducted, the user may continue to browse the previous page with respect to the specific element.

In summary, embodiments of the present application enable the following: in the process of displaying the target page, an element for guiding and prompting the user based on the user offers-related information may be provided. Specifically, the element may be used to display which commodities in the “shopping cart” associated with the user match what user offers and the completion status of the corresponding tasks, and the like. Through this solution, in the process of selecting commodities in the commodity information page, the user would be more aware of completing tasks such as “add-on orders” that is related to the use of the user offers. As such, the user offer information may be more effective in guiding the user to “add to cart,” thereby improving indicators such as commodity click-through rate, “add to cart rate,” conversion rate, etc., and it is also conducive to improve the verification and utilization rate of user offers.

Herein, in an optional implementation, when the user performs relevant operations in the current target page which leads to the change in the matching status of the user offers and/or in the task completion status, the style of the element and/or the presented content of the prompt information may further be updated so that the user may be able to perceive the changes more intuitively.

In the specific process of providing smart guiding prompts, the elements used for providing guiding prompts may have features such as being scalable, providing content with more varieties, etc. For example, in terms of the content variety, after a user has a new action such as “add to cart” on the current page, and if the task corresponding to the redeem conditions of a certain user offer is close to complete, the element may proactively push to the user commodities that may be used for “add-on orders,” so that the user may complete the “add-on order” directly using the element. Alternatively, if the user makes a new “add to cart” action on the current page and the redeem condition for using a certain user offer is met, the commodity information related to the user offer in the “shopping cart” may be extracted and displayed by means of the element. In addition, an operation option for initiating the checkout may be provided, so that the user can directly initiate the checkout using the above-mentioned element on the current page without having to return to the “shopping cart” page to initiate the checkout, thereby shortening the user's operation path.

In addition, from the perspective of technical implementation, the above-mentioned smart guiding and prompting function regarding user offers may be provided in the form of SDK. In this way, this SDK may be implanted in different pages corresponding to a plurality of different nodes in the shopping guide links, so that the above-mentioned guiding and prompting function may be uniformly presented in different pages. For example, different user offers may be presented in different colors in the element. When a page provides options for filtering commodities based on user offers, the options corresponding to different user offers may also be provided in different colors, which are consistent with the colors used for the corresponding user offers in the element. For the above scenario, when implemented through a unified SDK, the display logic of the elements themselves can be unified, and further the correspondence between the user offers and the colors may be unified on different pages, so that users gradually form the mindset that they can identify user offers by the colors.

### Embodiment II

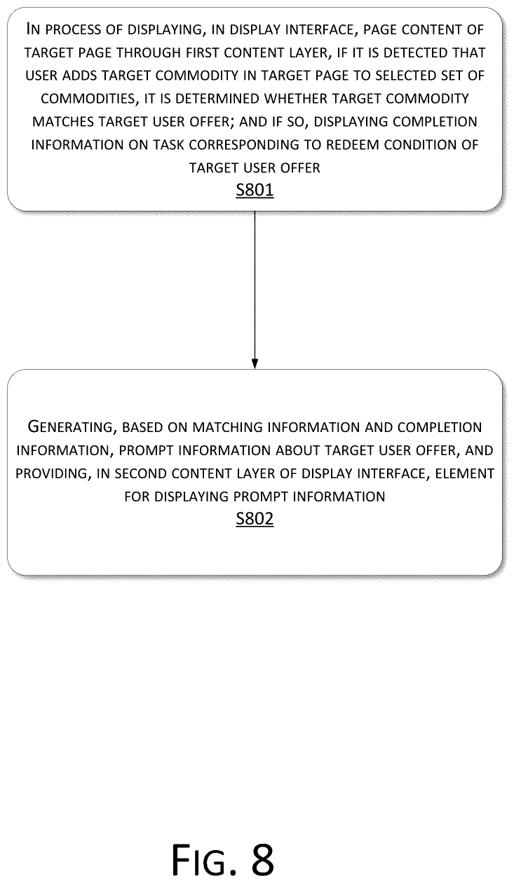

In the aforementioned Embodiment I, when the user initiates a browsing request for the target page, the matching status of the commodities in the user's “shopping cart” (the commodities added to the cart within the most recent threshold time may be selected by default) that matches user offers and the task completion status may be determined, and prompt information may be provided to the user. That is to say, as long as the target page is loaded and shown to the user, he or she does not need to perform specific operations such as adding to the cart therein, and may directly view such prompt information, and then complete the adding to the cart action under the guidance of such prompt information. In another way, when the user completes the add-to-cart operation through the current target page, the determination of the matching status of the user offers, task completion status, and other information may be triggered, and corresponding prompt information may be provided when there is a match. Therefore, Embodiment II further provides an information prompt method for this situation. Referring to FIG. 8, the method may include:

S801: in a process of displaying, in a display interface, page content of a target page through a first content layer, if it is detected that a user adds a target commodity in the target page to a selected set of commodities, it is determined whether the target commodity matches a target user offer; and if so, displaying completion information on a task corresponding to a redeem condition of the target user offer; and

S802: generating, based on the matching information and the completion information, prompt information about the target user offer, and providing, in a second content layer of the display interface, an element for displaying the prompt information.

If a task corresponding to a redeem condition of the target user offer is not completed, the prompt information includes progress information of the task and the task completion dollar difference information.

If the task completion dollar difference information is less than a preset threshold, recommended commodity information may be further pushed using the element, the recommended commodity being within the eligible range for the target user offer, and an associated price attribute being slightly greater than the task completion dollar difference of the redeem condition.

If the task corresponding to the redeem condition of the target user offer is completed, a commodity subset within the selected set of commodities related to the target user offer and a corresponding checkout operation option may be displayed by means of the element, so as to initiate a checkout operation for the commodities in the commodity subset by means of the element.

### Embodiment III

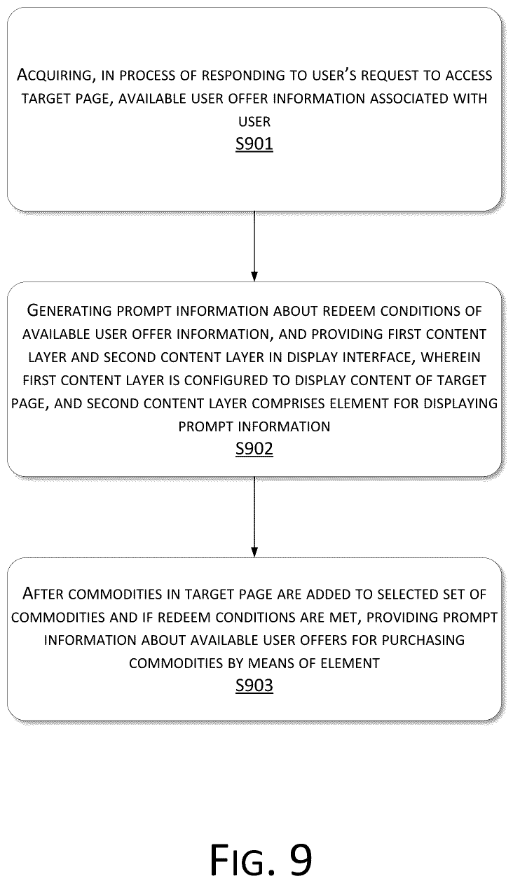

In the aforementioned Embodiment I, when a user browses a page at a specific node on the shopping guide link, the user may be prompted about the matching status of the items in his or her “shopping cart” that matches the user offers or the completion status of the task, so as to guide the user to complete the corresponding task by “adding to cart” more commodities in the current page, etc., and meet the redeem conditions for using the user offers. In another implementation, in addition to user offers such as “discounts for purchases over a certain dollar amount,” there may also be some coupon-related user offers. Such user offers may not require users to perform tasks like “add-on order,” and an example of such user offers include coupons like “first order discount” (such coupons are usually provided by a platform to users). For such user offers, as long as it is confirmed that the user is eligible for the offer, a prompt may be given on the pages corresponding to multiple nodes in the shopping guide link. When the user performs operations, such as adding to a cart, the user can also be prompted to place an order in order to use this user offer, and so on. Therefore, in Embodiment III, another information prompt method is provided. Referring to FIG. 9, the method may include:

S901: acquiring, in a process of responding to a user's request to access a target page, available user offer information associated with the user;

S902: generating prompt information about the redeem conditions of the available user offer information, and providing a first content layer and a second content layer in a display interface, wherein the first content layer is configured to display content of the target page, and the second content layer comprises an element for displaying the prompt information.

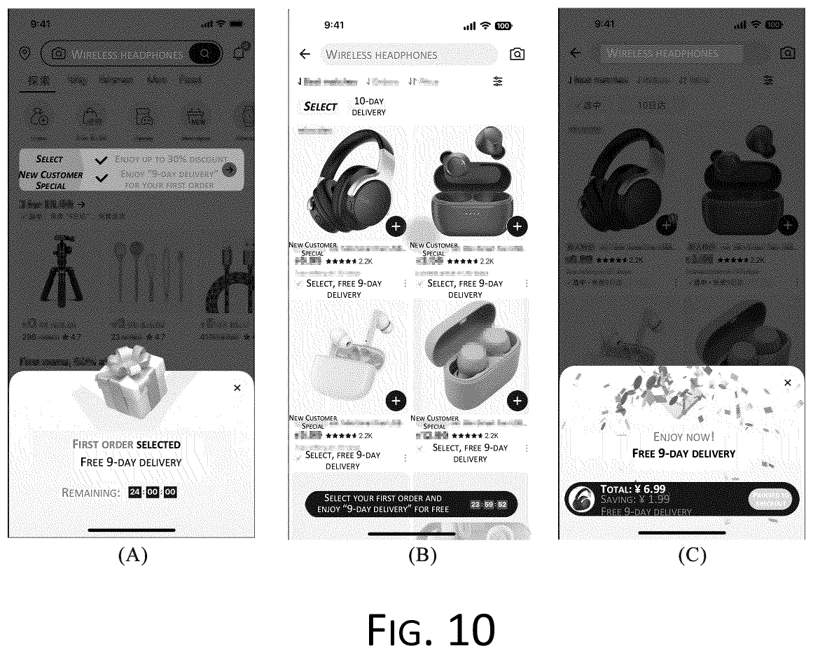

The element may also be scaled. For example, assuming that the current user is a new user of a certain function or is about to purchase a certain commodity for the first time and can use the “free shipping for the first order” coupon. When the user has just accessed the target page, as shown in FIG. 10 (A), a relatively large-sized element may be used to display prompt information such as “free 9-day delivery.” The prompt information may also be shown in the form of animation. If the user clicks to close the element, it may be displayed as shown in FIG. 10 (B), where the element may be reduced and continue to provide prompt information to the user in a way where less content on the page is obscured.

S903: After commodities in the target page are added to a selected set of commodities and if the redeem conditions are met, providing prompt information about the available user offers for purchasing the commodities by means of the element.

When the above prompt information is provided, if the user performs actions such as adding items to a cart on the current page, then since the “first order” redeem condition is met, the coupon may be used directly without having to perform tasks such as selecting other commodities for “add-on order.” Therefore, guiding prompt information such as “proceed to place an order” may be directly displayed through the aforementioned element to guide the user to complete the order and use the coupon. This will improve not only the conversion rate indicator, but also the coupon redemption and utilization rate indicator. Alternatively, in order to further shorten the user's operation path, as shown in FIG. 10 (C), operation options such as “proceed to checkout” may be provided directly through the aforementioned element, so that the user can directly initiate checkout for the commodities in the current target page without having to be redirected to the “shopping cart” page to initiate checkout.

### Embodiment IV

Embodiment IV further provides a display interface, wherein the display interface includes a first content layer and a second content layer, the first content layer is configured to display content of a target page, the target page being used to display commodity information; and the second content layer comprises an element for displaying prompt information related to user offers, wherein the prompt information is generated based on matching status information of commodities in a selected set of commodities associated with a user that matches user offers and completion status information on tasks corresponding to redeem conditions of the target user offers.

It should be noted that the embodiments of the present application may involve the use of user data. In practical applications, user-specific personal data may be used in the solutions described herein to the extent permitted by applicable laws and regulations (e.g., explicit consent from the users, effective notification to the users, etc.) in compliance with applicable laws and regulations of the country where the solutions are implemented.

Corresponding to the above-mentioned Embodiment I, the embodiment of the present application further provides an information prompting apparatus, which may include:
a user offer information acquisition unit, configured for acquiring, in a process of responding to a user's request to access a target page, matching status information of the commodities in a selected set of commodities associated with the user that matches at least one target user offer and completion information on a task corresponding to a redeem condition of the target user offer;
a prompt information display unit, configured for generating, based on the matching status information and the completion information, prompt information about the target user offer, and providing a first content layer and a second content layer in a display interface, wherein the first content layer being configured to display content of the target page, and the second content layer comprises an element for displaying the prompt information.

Herein, the target page is a page corresponding to multiple nodes on any shopping guide links in a commodity information service system.

The selected commodity set includes commodities selected from pages corresponding to the plurality of nodes on the plurality of shopping guide links.

Specifically, the method is applied to target function modules in the form of a software development kit (SDK), so that the target function modules may be implanted into pages corresponding to a plurality of nodes on shopping guide links of a plurality of access link nodes through the SDK.

Specifically, the user offer information acquisition unit may be specifically configured for:
acquiring, after receiving the user's request to access the target page and before the target page is displayed, the matching status information of the commodities already added to the selected set of commodities that matches at least one target user offer within the most recent threshold time, and the completion information of the task corresponding to the redeem condition of the target user offer, so that when a matched target user offer is found, the element is displayed at the time when the target page is displayed.

In addition, before the target page is displayed, if the commodities in the selected set of commodities do not match any of the target user offers, displaying the element in the target page when the commodities in the target page are newly added to the selected set of commodities and match at least one target user offer.

Herein, when the commodities in the selected set of commodities match a plurality of target user offers, prompt information respectively corresponding to the plurality of target user offers is provided in the element.

If a task completion dollar difference of the redeem condition for the target user offer is less than a preset threshold, recommended commodity information is pushed by means of the element, the recommended commodities being within the eligible range for the target user offer and an associated price attribute being slightly greater than the task completion dollar difference of the redeem condition.

In addition, the apparatus may further comprise:
an update display unit, configured for, after commodities in the target page are newly added to the selected set of commodities, if a change in the matching status information and/or the completion information is triggered, updating a style of the element and/or the content of the prompt information presented therein.

Specifically, the update display unit may be specifically used for:
after the commodities in the target page are newly added to the selected set of commodities and if the newly added commodities match new target user offers, adding, to the element, the prompt information about the new target user offers.

When the respective prompt information corresponding to the plurality of target user offers is displayed by means of the element, the prompt information respectively corresponding to the plurality of the target user offers is differentiated and shown using different colors.

If the target page includes a page configured for displaying information of the plurality of commodities in an aggregated manner, the apparatus may further include:
a filtering option providing unit, configured for providing, on the target page, an operation option for filtering commodities according to different target user offers, wherein a color attribute of the operation option is consistent with a color attribute of the prompt information corresponding to the target user offer.

Alternatively, the update display unit may be specifically used for:
after the commodities in the target page are newly added to the selected set of commodities, and if such results in the task completion dollar difference of the redeem condition of the corresponding target user offer being less than the preset threshold, pushing the recommended commodity information by means of the element, wherein the recommended commodities being within an eligible range for the target user offer, and the associated price attributes being slightly greater than the task completion dollar difference of the redeem condition.

Alternatively, the update display unit may be specifically used for:
after the commodities in the target page are newly added to the selected set of commodities, and if such changes a task status of the redeem condition of the corresponding target user offer to completed, displaying, by means of the element, a commodity subset within the selected set of commodities related to the target user offer and a corresponding checkout operation option, so as to initiate a checkout operation for the commodities in the commodity subset by means of the target page.

In addition, the apparatus may further comprise:
a redirect and display unit, configured for redirecting, after the element is executed by a target operation, to a page corresponding to the selected set of commodities for display, and classifying and displaying the commodities thereon according to the different matched target user offers.

Alternatively, a commodity display unit is configured for displaying, after the element is executed by a target operation, the commodity information related to the majority of target user offers in the selected set of commodities by means of the element, and providing an operation option for initiating the checkout operation.

Corresponding to the above-mentioned Embodiment II, the embodiment of the present application further provides an information prompting apparatus, which may include:
a user offer information acquisition unit, configured for the following: in a process of displaying, in a display interface, page content of a target page by means of a first content layer, if it is detected that a user adds a target commodity in the target page to a selected set of commodities, it is determined whether the target commodity matches a target user offer; and if so, displaying completion information on a task corresponding to a redeem condition of the target user offer; and
a prompt unit, configured for generating, based on the matching information and the completion information, prompt information about the target user offer, and providing, in a second content layer of the display interface, an element for displaying the prompt information.

Corresponding to the above-mentioned Embodiment III, the embodiment of the present application further provides an information prompting apparatus, which may include:
a user offer information acquisition unit, configured for acquiring, in a process of responding to a user's request to access a target page, available user offer information associated with the user;
an offer prompting unit, configured for generating prompt information about the redeem conditions of the available user offer information, and providing a first content layer and a second content layer in a display interface, wherein the first content layer is configured to display content of the target page, and the second content layer comprises an element for displaying the prompt information;
a purchase prompt unit, configured for, after commodities in the target page are added to a selected set of commodities and if the redeem conditions are met, providing prompt information about the available user offers for purchasing the commodities by means of the element.

In addition, the apparatus may further comprise:
a checkout option providing unit, configured for, when the element provides prompt information about the available user offers for purchasing the commodities, providing, in the element, an operation option for initiating checkout for the commodities, so as to initiate the checkout for the commodities in the target page.

In addition, the embodiment of the present application further provides a computer-readable storage medium having a computer program stored thereon which, when executed by a processor, implements the steps of the methods described in any of the above-described method embodiments.

Also provided is an electronic device, comprising:
one or more processors; and
a memory associated with the one or more processors, the memory being configured to store program instructions which, when read and executed by the one or more processors, execute the steps of the methods described in any of the above-described method embodiments.

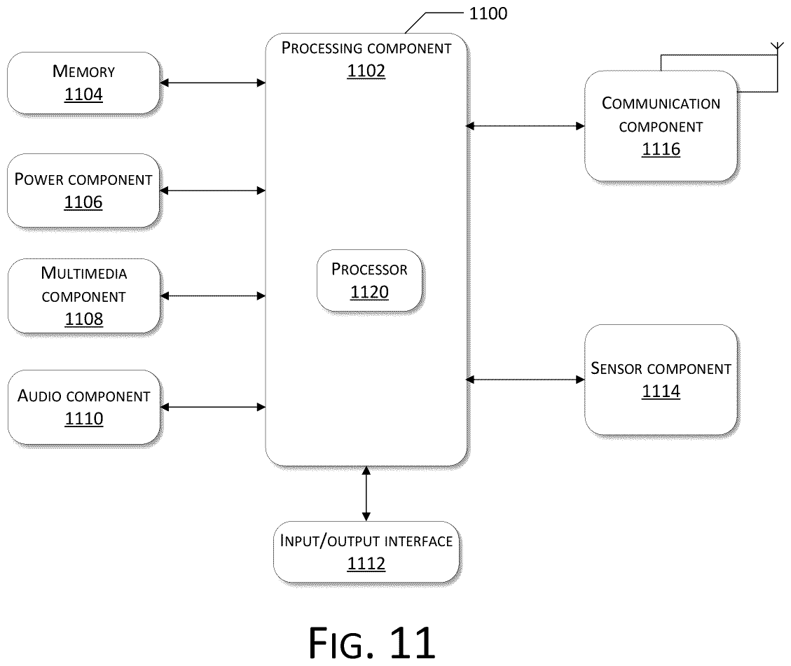

FIG. 11 exemplarily shows the architecture of an electronic device, for example, the device 1100 may be a mobile phone, a computer, a digital broadcasting terminal, a messaging device, a game console, a tablet device, a medical device, a fitness device, a personal digital assistant, an aircraft, and the like.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 generally controls the overall operation of the device 1100, such as operations associated with display, phone calls, data communications, camera operations, and recording operations. The processing component 1102 may include one or more processors 1120 to execute instructions to implement all or part of the steps of the methods provided by the technical solutions of the present disclosure. Additionally, the processing component 1102 may include one or more modules to facilitate the interaction between the processing component 1102 and other components. For example, the processing component 1102 may include a multimedia module to facilitate the interaction between the multimedia component 1108 and the processing component 1102.

The memory 1104 is configured to store various types of data to support operations on the device 1100. Examples of such data include instructions, contact data, phonebook data, messages, pictures, videos and the like used for any application programs or methods operating on the device 1100. The memory 1104 may be implemented by any type of volatile or non-volatile memory device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 1106 provides power to the various components of the device 1100. The power components 1106 may include a power management system, one or more power supplies, and other components associated with generating, managing, and distributing power for the device 1100.

The multimedia component 1108 includes a screen that provides an output interface between the device 1100 and users. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swiping, and gestures on the touch panel. The touch sensor may not only sense the boundary of a touch or slide action, but also detect the duration and pressure related to the touch or sliding operation. In some embodiments, the multimedia component 1108 includes a front-facing camera and/or a rear-facing camera. When the device 1100 is in an operation mode, such as a photo-taking mode or a video mode, the front-facing camera and/or the rear-facing camera may receive external multimedia data. Each of the front-facing camera and/or the rear-facing camera may be a fixed optical lens system or have focal length and optical zoom capability.

The audio component 1110 is configured to output and/or input audio signals. For example, the audio component 1110 includes a microphone (MIC) configured to receive an external audio signal when the device 1100 is in an operating mode, for example, in a call mode, recording mode, or voice recognition mode. The received audio signal may be further stored in the memory 1104 or sent through the communication component 1116. In some embodiments, the audio component 1110 further includes a speaker for outputting an audio signal.

The I/O interface 1112 provides an interface between the processing component 1102 and a peripheral interface module that may be a keyboard, a clickwheel, buttons, or the like. These buttons may include, but are not limited to: home button, volume buttons, start button, and lock button.

The sensor component 1114 includes one or more sensors for providing status assessment of various aspects of the device 1100. For example, the sensor component 1114 can detect the open/closed state of the device 1100, and the relative positioning of components such as the display and keypad of the device 1100. The sensor component 1114 can further detect a change in the position of the device 1100 or a component of the device 1100, the presence or absence of user contact with the device 1100, orientation or acceleration/deceleration of the device 1100, and temperature changes of the device 1100. The sensor component 1114 may include a proximity sensor configured to detect the presence of nearby objects in the absence of any physical contact. The sensor component 1114 may also include a light sensor such as a CMOS or CCD image sensor for use in imaging applications. In some embodiments, the sensor component 1114 may also include an acceleration sensor, a gyroscope sensor, a magnetic sensor, a pressure sensor, or a temperature sensor.

The communication component 1116 is configured to facilitate wired or wireless communications between the device 1100 and other devices. The device 1100 can access a wireless network based on communication standards, such as mobile communication networks like Wi-Fi, or 2G, 3G, 4G/LTE, and 5G. In an exemplary embodiment, the communication component 1116 receives, through a broadcast channel, broadcast signals or broadcast-related information from an external broadcast management system. In an exemplary embodiment, the communication component 1116 further comprises a near field communication (NFC) module to facilitate short range communications. For example, the NFC module can be implemented based on the radio frequency identifier (RFID) technology, the infrared data association (IrDA) technology, the ultra-wideband (UWB) technology, the Bluetooth (BT) technology, and other technologies.

In an exemplary embodiment, the device 1100 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the above methods.

In an exemplary embodiment, a non-transitory computer-readable storage medium having instructions is also provided, such as the memory 1104 having instructions, and the above-mentioned instructions can be executed by the processor 1120 of the device 1100 to complete the method provided by the technical solution of the present disclosure. For example, the non-transitory computer-readable storage medium may be ROM, random access memory (RAM), CD-ROM, a magnetic tape, a floppy disk, an optical data storage device, and the like.

As can be seen from the description of the above embodiments, it is clear that the present application can be implemented by means of software plus the necessary general hardware platform. Based on such an understanding, the part of the technical solution of the present application, which is essential or contributes to the prior art, can be embodied in the form of a software product. The computer software product can be stored in a storage medium, such as a ROM/RAM, a magnetic disk, and an optical disk, and include several instructions for enabling a computer device (which may be a personal computer, a server, a network device, or the like) to execute the methods described in the embodiments or some parts of the embodiments of the present application.

The various embodiments in this specification are all described in a progressive manner. The various embodiments may refer to other embodiments for the same or similar parts, and each of the embodiments focuses on the parts differing from the other embodiments. In particular, the system or system embodiments are basically similar to the method embodiments, the description for these embodiments is thus relatively brief, and the description of the method embodiments may be referred to for relevant details. The system and system embodiments described above are only examples, wherein the units described as separate components may or may not be physically separated; and the components displayed as units may or may not be physical units; that is, the units may be located in one place, or may be distributed on a plurality of network units. Some or all of the modules may be selected according to actual needs to achieve the objectives of the solutions of the embodiments. Those of ordinary skill in the art may understand and implement the embodiments without creative efforts.

The information prompt method and electronic device provided by the present application have been introduced in detail above. The principles and implementations of the present application are described with specific examples herein. The descriptions of the above embodiments are only used to help understand the methods and the core idea of the present application. At the same time, for those skilled in the art, according to the idea of the present application, there will be modifications in specific implementations and the application scope. In conclusion, the content of the present specification should not be construed as a limitation to the present application.

What is claimed is:

1. An information prompt method, wherein the method comprises:
acquiring, in a process of responding to a user's request to access a target page, matching status information of the commodities in a selected set of commodities associated with the user that matches at least one target user offer and completion information on a task corresponding to a redeem condition of the target user offer; and
generating, based on the matching status information and the completion information, prompt information about the target user offer, and providing a first content layer and a second content layer in a display interface, wherein the first content layer being configured to display content of the target page, and the second content layer comprises an element for displaying the prompt information.

2. The method according to claim 1, wherein
the method is applied to target function modules in the form of a software development kit (SDK), so that the target function modules may be implanted, by means of the SDK, into pages corresponding to a plurality of nodes on shopping guide links of a plurality of access link nodes in a commodity information service system.

3. The method according to claim 1, wherein
the acquiring, in the process of responding to the user's request to access the target page, the matching status information of the commodities in the selected set of commodities associated with the user that matches at least one target user offer and the completion information on the task corresponding to the redeem condition of the target user offer comprises:
acquiring, after receiving the user's request to access the target page and before the target page is displayed, the matching status information of the commodities already added to the selected set of commodities that matches at least one target user offer within the most recent threshold time and the completion information of the task corresponding to the redeem condition of the target user offer, so that when a matched target user offer is found, the element is displayed at the time when the target page is displayed.

4. The method according to claim 1, wherein
when the commodities in the selected set of commodities match a plurality of target user offers, prompt information respectively corresponding to the plurality of target user offers is provided in the element.

5. The method according to claim 1, wherein the method comprises:
if a task completion dollar difference of the redeem condition for the target user offer is less than a preset threshold, recommended commodity information is pushed by means of the element, the recommended commodity being within the eligible range for the target user offer and an associated price attribute being slightly greater than the task completion dollar difference of the redeem condition.

6. The method according to claim 1, further comprising:
after commodities in the target page are newly added to the selected set of commodities, if a change in the matching status information and/or the completion information is triggered, updating a style of the element and/or the content of the prompt information presented therein.

7. The method according to claim 6, wherein
the updating the style of the element and/or the content of the prompt information presented therein comprises:
after the commodities in the target page are newly added to the selected set of commodities and if the newly added commodities match new target user offers, adding, to the element, the prompt information about the new target user offers.

8. The method according to claim 7, wherein
when the respective prompt information corresponding to the plurality of target user offers is displayed by means of the element, the prompt information respectively corresponding to the plurality of the target user offers is differentiated and shown using different colors.

9. The method according to claim 8, wherein
the target page comprises a page configured for displaying information of the plurality of commodities in an aggregated manner; and
the method further comprises:
providing, on the target page, an operation option for filtering commodities according to different target user offers, wherein a color attribute of the operation option is consistent with a color attribute of the prompt information corresponding to the target user offer.

10. The method according to claim 6, wherein
the updating the style of the element and/or the content of the prompt information presented therein comprises:
after the commodities in the target page are newly added to the selected set of commodities, and if such results in the task completion dollar difference of the redeem condition of the corresponding target user offer being less than the preset threshold, pushing the recommended commodity information by means of the element, wherein the recommended commodities being within an eligible range for the target user offer, and the associated price attributes being slightly greater than the task completion dollar difference of the redeem condition.

11. The method according to claim 6, wherein
the updating the style of the element and/or the content of the prompt information presented therein comprises:
after the commodities in the target page are newly added to the selected set of commodities, and if such changes a task status of the redeem condition of the corresponding target user offer to complete, displaying, by means of the element, a commodity subset within the selected set of commodities related to the target user offer and a corresponding checkout operation option, so as to initiate a checkout operation for the commodities in the commodity subset by means of the element.

12. The method according to claim 1, wherein the method further comprises:
redirecting, after the element is executed by a target operation, to a page corresponding to the selected set of commodities for display, and classifying and displaying the commodities thereon according to the different matched target user offers.

13. The method according to claim 1, wherein the method further comprises:
displaying, after the element is executed by a target operation, the commodity information related to the majority of target user offers in the selected set of commodities by means of the element, and providing an operation option for initiating the checkout operation.

14. An information prompt method, wherein the method comprises:
in a process of displaying, in a display interface, page content of a target page by means of a first content layer, if it is detected that a user adds a target commodity seen in the target page to a selected set of commodities, it is determined whether the target commodity matches a target user offer; and if so, displaying completion information on a task corresponding to a redeem condition of the target user offer; and
generating, based on the matching information and the completion information, prompt information about the target user offer, and providing, in a second content layer of the display interface, an element for displaying the prompt information.

15. The method according to claim 14, wherein the method further comprises:
if a task corresponding to a redeem condition of the target user offer is not completed, including, in the prompt information, progress information of the task and the task completion dollar difference information.

16. The method according to claim 15, wherein the method further comprises:
if the task completion dollar difference information is less than a preset threshold, recommended commodity information is further pushed by means of the element, the recommended commodity being within the eligible range for the target user offer, and an associated price attribute being slightly greater than the task completion dollar difference of the redeem condition.

17. The method according to claim 14, wherein the method further comprises:
if the task corresponding to the redeem condition of the target user offer is completed, displaying, by means of the element, a commodity subset within the selected set of commodities related to the target user offer and a corresponding checkout operation option, so as to initiate a checkout operation for the commodities in the commodity subset by means of the element.

18. An information prompt method, wherein the method comprises:
acquiring, in a process of responding to a user's request to access a target page, available user offer information associated with the user;
generating prompt information about the redeem conditions of the available user offer information, and providing a first content layer and a second content layer in a display interface, wherein the first content layer is configured to display content of the target page, and the second content layer comprises an element for displaying the prompt information; and
after commodities in the target page are added to a selected set of commodities and if the redeem conditions are met, providing prompt information about the available user offers for purchasing the commodities by means of the element.
